(19) United States
(12) Patent Application Publication
(10) Pub. No.: US 2023/0200591 A1
(43) Pub. Date: Jun. 29, 2023

(54) FLIPPING STRUCTURE, INGREDIENT LOADING DEVICE COMPRISING THE SAME, AND AUTOMATIC STIR-FRYER COMPRISING THE SAME

(71) Applicant: Shanghai Aican Robot (Group) Co., Ltd., Shanghai (CN)

(72) Inventors: Guang HE, Shanghai (CN); Qing HE, Shanghai (CN)

(21) Appl. No.: 18/113,635

(22) Filed: Feb. 24, 2023

Related U.S. Application Data
(63) Continuation-in-part of application No. PCT/CN2021/110167, filed on Aug. 3, 2021.

(30) Foreign Application Priority Data
Aug. 24, 2020 (CN) 202010859764.1

(51) Int. Cl. A47J 47/01; A47J 37/10

(52) U.S. Cl. CPC A47J 47/01; A47J 37/108

(57) ABSTRACT

A flipping structure includes an ingredient box, a container, a moving module and a driving mechanism. The container is configured to carry the ingredient box; the moving module is configured to directionally move the container; the driving mechanism is configured to flip the ingredient box; the driving mechanism includes a rotating shaft and at least one clamp block fixedly disposed on the rotating shaft; the ingredient box includes a front face, a back face, and a connecting piece. The connecting piece is fixed on the front face or the back face. The connecting piece includes a slot. When in use, the ingredient box moves with the container to face the at least one clamp block, and the at least one clamp block is nested in the slot. The clamp block is clamped in the slot through a clearance fit.

### CROSS-REFERENCE TO RELATED APPLICATIONS

This application is a continuation-in-part of International Patent Application No. PCT/CN2021/110167 with an international filing date of Aug. 3, 2021, designating the United States, now pending, and further claims foreign priority benefits to Chinese Patent Application No. 202010859764.1 filed Aug. 24, 2020. The contents of all of the aforementioned applications, including any intervening amendments thereto, are incorporated herein by reference.

### BACKGROUND

The disclosure relates to the field of an automatic stir-fryer, and more particularly, to a flipping structure, an ingredient loading device comprising the same, and an automatic stir-fryer comprising the same.

Current cooking equipment is becoming more intelligent, and automatic loading of ingredients is an indispensable link in intelligent cooking.

A conventional automatic ingredient loading device for a stir-fryer typically includes a frying pan, a body, a base, a bracket, a first driving unit, an installation seat, a plurality of ingredient boxes, an attraction module and a second driving unit; the base is fixedly mounted on the body, the installation seat is slidable on the base, the first driving unit is configured to enable the installation seat to slide; the plurality of ingredient boxes is mounted on the installation seat to carry ingredients; the bracket is fixedly disposed on the body; the attraction module is rotatably mounted on the bracket; the second driving unit is connected to the attraction module; the attraction module is driven by the second driving unit so as to rotate and attract the plurality of ingredient boxes, thus automatically adding the ingredients into the frying pan during the continuous rotation.

The shortcomings of the conventional automatic feeding mechanism are as follows:

1. The ingredient box is attached to the flipping mechanism by magnetic suction, which leads to an unstable connection, so that the position of the plurality of ingredient boxes is inaccurately located, resulting in unstable flipping.

2. The installation seat is mounted on a sliding rail; a transmission belt is used in conjunction with a flipping mechanism; the flipping mechanism is driven by a linkage mechanism and flips the plurality of ingredient boxes. Therefore, the automatic ingredient loading device occupies a large space, resulting in a bulky machine.

### SUMMARY

The disclosure provides a flipping structure, an ingredient loading device comprising the same, and an automatic stir-fryer comprising the same.

The flipping structure comprises an ingredient box, a container, a moving module and a driving mechanism; the container is configured to carry the ingredient box; the moving module is configured to directionally move the container; the driving mechanism is configured to flip the ingredient box; the driving mechanism comprises a rotating shaft and at least one clamp block fixedly disposed on the rotating shaft; the ingredient box comprises a front face, a back face, and a connecting piece; the connecting piece is fixed on the front face or the back face; the connecting piece comprises a slot. When in use, the ingredient box moves with the container to face the at least one clamp block, and the at least one clamp block is nested in the slot; the clamp block is clamped in the slot through a clearance fit; as the rotating shaft rotates, the clamp block carries the ingredient box to turn over around the rotating shaft.

In a class of this embodiment, the clamp block is a member sleeved or welded to the rotating shaft, and has a triangular, quadrilateral, pentagonal or oval cross section perpendicular to the rotating shaft.

In a class of this embodiment, the connecting piece is an integrated structure comprising a base board, an upper board, and a lower board; the base board is fixed on the ingredient box; the upper board and the lower board are connected to an upper end and a lower end of the base board, respectively; and the slot is formed by space between the upper board and the lower board.

In a class of this embodiment, a fixing unit is disposed between an inner surface of the container and an outer surface of the ingredient box to prevent the ingredient box from wobbling in the container.

The ingredient loading device comprises the flipping structure and two frame plates; the driving mechanism of the flipping structure further comprises a first drive unit; two ends of the rotating shaft are respectively carried by the two frame plates; the first drive unit comprises an output end fixedly connected to one end of the rotating shaft; the moving module of the flipping structure comprises a second drive unit, a drive screw, two positioning slide plates and at least one positioning slide bar; two ends of both the drive screw and the at least one positioning slide bar are carried by the two frame plates, respectively; the rotating shaft, the drive screw, and the at least one positioning slide bar are parallel to each other; the two positioning slide plates are respectively connected to two sides of a front face or a back face of the container; an upper part and a lower part of a back surface of each of the two positioning slide plates are provided with two sliding sleeves, respectively; one of the two sliding sleeves is in a sliding connection to the rotating shaft and the other sliding sleeve is in a sliding connection to the at least one positioning slide bar; each of the two positioning slide plates further comprises a threaded sleeve disposed between the two sliding sleeves; the threaded sleeve is disposed on the drive screw; one end of the drive screw is connected to an output end of the second drive unit; and the container carries the ingredient box and is driven by the second drive unit to move reciprocally along the drive screw. In certain examples, the moving module comprises two positioning slide bars respectively in a sliding connection to the two sliding sleeves.; one of the two positioning slide bars is disposed between the rotating shaft and the drive screw, and the other positioning slide bars is disposed below the drive screw.

In a class of this embodiment, each of the two positioning slide plates comprises a backboard, a lateral plate and a lower base plate; the two sliding sleeves and the threaded sleeve are disposed on an outer surface of the backboard; a middle edge of the lateral plate is provided with a gap; the container is supported by the lower base plate; the container comprises an outer side and a button pin is disposed on the outer side; and the button pin is clamped in the gap so that the two positioning slide plates are connected to the container.

In a class of this embodiment, the front face or the back face of the ingredient box without the connecting piece comprises an upper part and a lower part; the upper part is straight, and the lower part is an arc-shaped surface or inclined surface; and a bottom edge of the arc-shaped surface or inclined surface is connected to a bottom face of the ingredient box.

In a class of this embodiment, the moving module of the flipping structure comprises at least two positioning slide bars, comprising an upper positioning slide bar above the rotating shaft and the drive screw, and a lower positioning slide bar below the drive screw; and the two sliding sleeves sleeve the upper positioning slide bar and the lower positioning slide bar, respectively.

In a class of this embodiment, the ingredient loading device comprises a plurality of ingredient boxes each with at least one connecting piece; when one of the plurality of ingredient boxes needs to be flipped, at least one clamp block is correspondingly clamped in the slot of the at least one connecting piece of the one ingredient box, and other clamp blocks are disengaged with the slots of the connecting pieces of the ingredient boxes not to be flipped.

In a class of this embodiment, for a wide ingredient box, the wide ingredient box comprises two connecting pieces disposed on two sides of the wide ingredient box, respectively.

An automatic stir-fryer comprises a chamber, a frying pan, and the ingredient loading device; wherein the ingredient loading device is disposed between an opening of the frying pan; the chamber comprises a first inner wall provided with a first supporting plate and a second inner wall provided with a second supporting plate; the first supporting plate is provided with a first through hole for receiving the rotating shaft and a second through hole for receiving the drive screw; the second supporting plate is provided with a locking piece; one of the two frame plates comprises a hole; the locking piece is fixed in the hole so that the two frame plates are fixed between the first supporting plate and the second supporting plate; and one end of the rotating shaft and one end of the drive screw respectively pass through the first through hole and the second through hole and are connected to output ends of the first drive unit and the second drive unit disposed on an outer wall of the chamber.

The following advantages are associated with the disclosure: as the one ingredient box moves reciprocally along the drive screw, the one clamp block is correspondingly clamped in or disengaged from the slot of the connecting piece of the one ingredient box. The one ingredient box moves only a short distance to a designated location, resulting in a shorter rotating shaft and drive screw compared to the prior arts, thereby reducing the space occupied by the ingredient box in the automatic stir-fryer.

### BRIEF DESCRIPTION OF THE DRAWINGS

FIG. 1 is a first perspective view of an ingredient loading device according to one example of the disclosure;

FIG. 2 is an exploded view of an ingredient loading device according to one example of the disclosure;

FIG. 3A is an exploded view of an ingredient box and a container according to one example of the disclosure;

FIG. 3B is a local enlarged view of part A in FIG. 3A;

FIG. 4A is a schematic diagram of installation of a container according to one example of the disclosure;

FIG. 4B is an exploded view of the container of FIG. 4A;

FIG. 5 is a first schematic diagram of flipping of an ingredient unloading device according to one example of the disclosure;

FIG. 6 is a second perspective view of an ingredient loading device according to one example of the disclosure;

FIG. 7 is a first schematic diagram of flipping of the ingredient unloading device according to one example of the disclosure;

FIG. 8 is a first schematic diagram of arrangement of an ingredient loading device according to one example of the disclosure;

FIG. 9 is a second schematic diagram of arrangement of an ingredient loading device according to one example of the disclosure;

FIG. 10 is a third schematic diagram of arrangement of an ingredient loading device according to one example of the disclosure;

FIG. 11 is a perspective view of an automatic stir-fryer according to one example of the disclosure;

FIG. 12A is a schematic diagram of assembly of an ingredient loading device according to one example of the disclosure;

FIG. 12B is a local enlarged view of part B in FIG. 12A;

FIG. 13A is another schematic diagram of assembly of an ingredient loading device according to one example of the disclosure; and

FIG. 13B is a local enlarged view of part C in FIG. 13A.

In the drawings, the following reference numbers are used: 1. Ingredient box; 11. Connecting piece; 12. Slot; 13. Base board; 14. Upper board; 5. Lower board; 2. Container; 22. Side plate; 23. Front plate; 24. Back plate; 25. Partition; 26. Positioning convex strip; 27. Positioning groove; 28. Button pin; 3. Driving mechanism; 31. First drive unit; 32. Rotating shaft; 33. Clamp block; 4. Moving module; 41. Second drive unit; 42. Drive screw; 43. Positioning slide bar; 44. Positioning slide plate; 441. Backboard; 442. Lateral plate; 443. Lower base plate; 45. Gap; 46. First sliding sleeve; 47. Second sliding sleeve; 48. Threaded sleeve; 5. Frame plate; 51. First hole; 52. Second hole; 53. Third hole; 54. Fourth hole; 6. Limit switch; 100. Ingredient loading device; 200. Automatic stir-fryer; 210. Frying pan; 220. Chamber; 221. First supporting plate; 222. Second supporting plate; 223. Upper plate; 224. Lower plate; 225. Base plate; 226. Baffle plate; 227. Locking piece; 228. First through hole; and 229. Second through hole.

### DETAILED DESCRIPTION OF THE EMBODIMENTS

The disclosure provides an automatic stir-fryer 200 comprising an ingredient loading device 100; the ingredient loading device comprises a flipping structure.

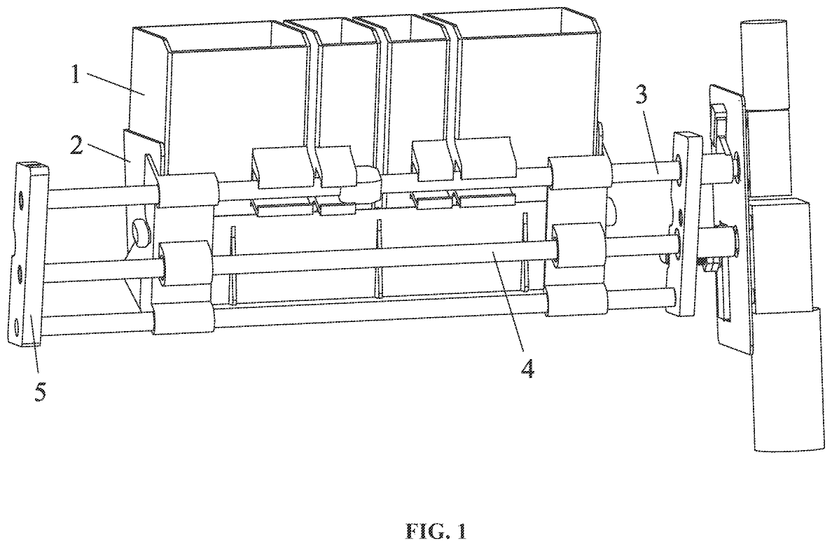

As shown in FIGS. 1-10, the flipping structure comprises an ingredient box 1, a container 2, a driving mechanism 3, and a moving module 4.

The ingredient box 1 is used to hold an ingredient stuff to be cooked. The container 2 is used to support the ingredient box 1. The moving module 4 is configured to directionally move the container 2. The driving mechanism 3 is automatically connected to or separated from the ingredient box 1 so as to control the flipping of the ingredient box 1. The ingredient stuff to be cooked is thus poured into a frying pan 210.

1. Flipping Structure

1.1 Ingredient Box

The quantity and specification of the ingredient box 1 is determined by a ratio of the amount of a variety of ingredients to be cooked.

The ingredient box 1 comprises a non-toxic, harmless and pollution-free material; the ingredient box 1 comprises an opening, a front surface, a back face, a bottom face, and a connecting piece 11; the connecting piece 11 is connected to the back face; the connecting piece 11 is integrally formed with the ingredient box 1; optionally, the connecting piece 11 is detachably connected to the ingredient box 1 by a screw, an adhesive or welding.

The connecting piece 11 comprises one of two following structures:

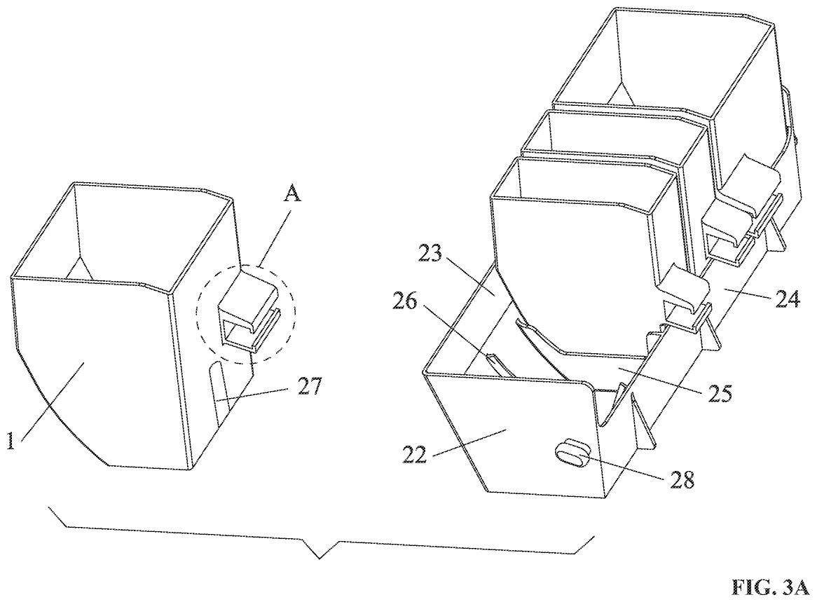

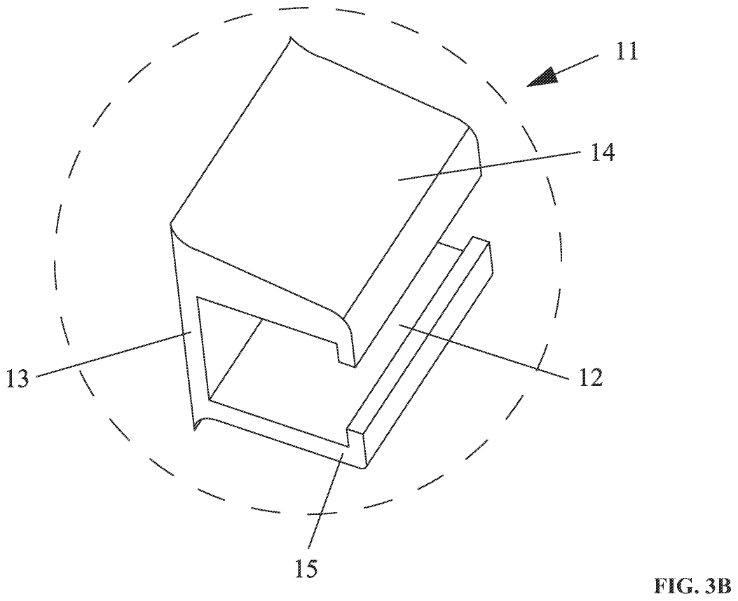

1) As shown in FIGS. 3A-3B, the connecting piece 11 is an integrated structure comprising a base board 13, a upper board 14 and a lower board 15; the base board 13 is fixed on the ingredient box 1; the upper board 14 and the lower board 15 are connected to an upper end and a lower end of the base board 13, respectively; both the upper board 14 and the lower board 15 comprise an arc-shaped hook; the two arc-shaped hooks are disposed opposite each other, but not physically in contact; a slot 12 is formed by space between the upper board 14 and the lower board 15; and the slot is in the shape of a triangular prism, a quadrangular prism, a pentagonal prism or an ellipsoid.

2) The connecting piece 11 comprises a support rod (not shown), a first clamp plate, and a second clamp plate; the support column comprises an outer surface with an external thread; the back face of the ingredient box 1 comprises a threaded hole; the support column is screwed to the threaded hole so that the connecting piece 11 is fixedly connected to the ingredient box; both the first clamp plate and the second clamp plate comprise a first end and a second end; the first ends of the first clamp plate and the second clamp plate are connected together; both the second ends of the upper board and the lower board comprise an arc-shaped hook; the two arc-shaped hooks are disposed opposite each other, but not physically in contact; a slot 12 is formed by space between the upper board 14 and the lower board 15; and the slot is in the shape of a triangular prism, a quadrangular prism, a pentagonal prism or an ellipsoid.

1.2 Container

As shown in FIGS. 3A-3B, the container comprises an opening, a bottom plate, two side plates 22, a front plate 23 and a back plate 24; the opening is formed by the bottom plate, the two side plates, the front plate 23, and the back plate 24; the ingredient box 1 is disposed in the container 2.

The container 2 is disposed on the moving module 4 and carries the ingredient box to move reciprocally above the frying pan 210.

The front face or the back face of the ingredient box 1 without the connecting piece 11 comprises an upper part and a lower part; the upper part is straight, and the lower part is an arc-shaped surface or inclined surface; and a bottom edge of the arc-shaped surface or inclined surface is connected to a bottom face of the ingredient box 1; the highest point of the front plate 23 is below or at the same height as the lowest point of the ingredient box 1, preventing the front plate 23 from blocking the flipping of the ingredient box and thus increasing the space utilization of the inside of the automatic stir-fryer.

The flipping structure further comprises a plurality of partitions 25 spaced longitudinally apart in the second box 2; the plurality of partitions 25 is integrally formed with the container 2; and the plurality of partitions separates the container 2 into a plurality of spaces for receiving the ingredient box 1.

The container 2 is used to support the ingredient box 1 and limit potential changes in the position of the ingredient box 1, preventing the ingredient box 1 from wobbling in the container 2, and thus the ingredients are poured into the frying pan.

The flipping structure further comprises a plurality of positioning structures disposed between the ingredient box 1 and the container 2.

1) Each of the plurality of positioning structures comprises a positioning convex strip 26 and a positioning groove 27; the positioning convex strip 26 is correspondingly disposed in one of the plurality of spaces; the positioning groove 27 is disposed on the arc-shaped or inclined surface of the ingredient box 1; and the positioning convex strip 26 is nested in the positioning groove 27; or

2) each of the plurality of positioning structures comprises at least one positioning column and at least one guide groove (not shown); the at least one positioning column is spaced apart in the plurality of spaces; the at least one guide groove is disposed on the bottom face of the ingredient box; and the at least one positioning column is correspondingly inserted into the at least one guide groove.

The moving module 4 is one of transmission mechanisms commonly used in conventional automatic stir-fryers.

1.3 Driving Mechanism

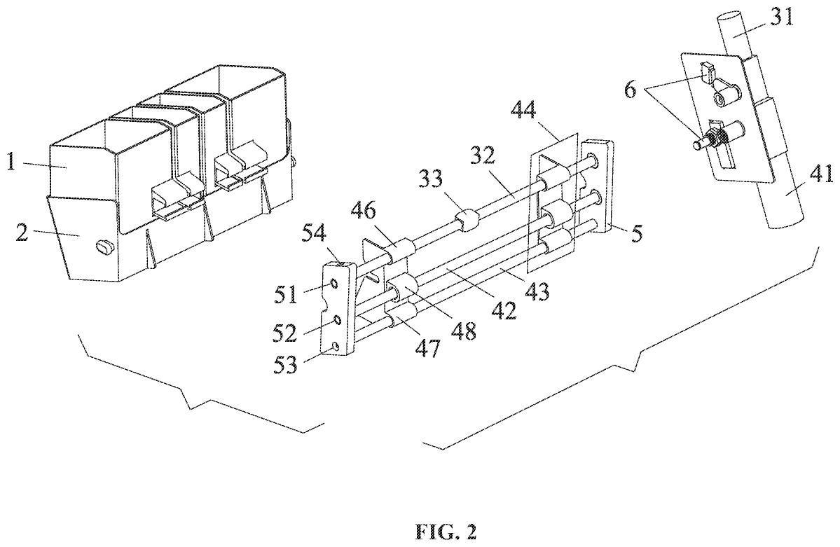

Referring to FIGS. 1 and 2, the driving mechanism 3 comprises a first drive unit 31, a rotating shaft 32 and two frame plates 5; both the two frame plates 5 comprise a first hole 51; two ends of the rotating shaft 32 are respectively inserted into the two first holes 51 and carried by the two frame plates 5; the first drive unit 31 comprises an output end; one end of the rotating shaft 32 passes through the one of the first holes 51 and is connected to the output end.

Preferably, the first drive unit 31 is a driving motor provided with a Hall sensor; the first drive unit 31 is used to drive the rotation of the rotating shaft 32 and precisely control the angle and speed of the flipping of the ingredient box 1.

The flipping structure further comprises at least one clamp block 33 fixed on the rotating shaft 32. In certain examples, only one clamp block 33 is disposed directly above the frying pan 210; when the ingredient box 1 is turned over, the ingredients are poured into the frying pan 210.

The at least one clamp block 33 and the rotating shaft 32 are connected as follows:

1) The at least one clamp block 33 sleeves the rotating shaft 32; specifically, the at least one clamp block 33 comprises a through hole; the rotating shaft 31 passes through the clamp block 33 and fixed by welding, an adhesive or a locking pin; optionally, the at least one clamp block 33 is movable on the rotating shaft 32. In the example, the at least one clamp block 33 is clamped in the slot of the connecting piece, and the rotating shaft 32 passes through the through hole of the at least one clamp block 33.

2) The at least one clamp block is a component (not shown) connected to the outside surface of the rotating shaft by welding, a snap-fit joint, an adhesive or a locking pin.

The at least one clamp block 33 has a triangular, quadrilateral, pentagonal or oval cross section perpendicular to the rotating shaft 32.

1.4 A Connection Between the Connecting Piece 33 and the Slot 12

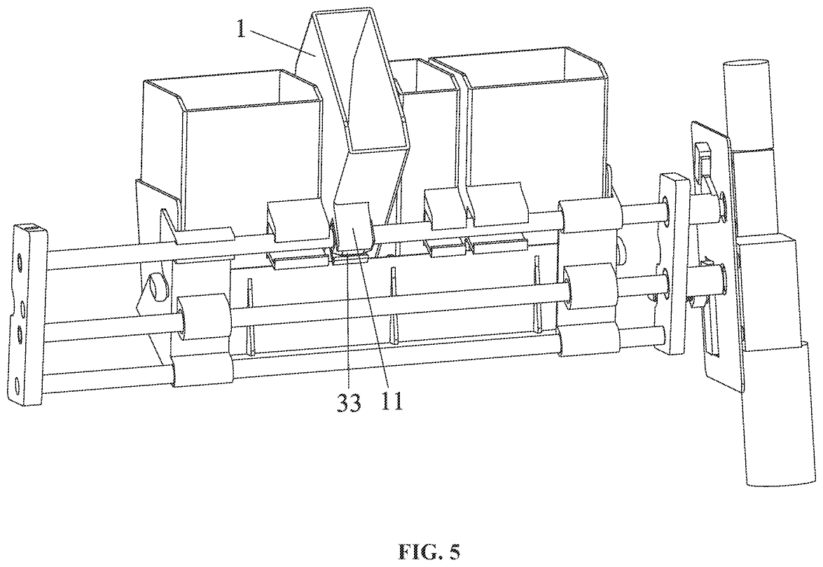

As shown in FIGS. 1 and 5, the container 2 carries a plurality of ingredient boxes and driven by the moving module 4 and the limit switch to stay at a position above the frying pan 210; and the plurality of ingredient boxes 1 is opposite to the at least one clamp block 33; the at least one clamp block 33 is clamped in the slot 12 through a clearance fit; as the rotating shaft rotates, the at least one clamp block carries the connecting piece to rotate as well, causing the plurality of ingredient boxes to turn over around the rotating shaft, so the ingredients are poured into the frying pan 210; the ingredient box 1 is then driven by the driving mechanism 3 to turn over in reverse direction and move back into the container; the container is then driven by the moving module 4 and carries the plurality of ingredient boxes 1 to face the at least one clamp block; the at least one clamp block is clamped in or disengaged with the slot of the connecting piece.

2. Ingredient Loading Device 100

The ingredient loading device 100 comprises the flipping structure; the flipping structure comprises the moving module 4 and a connecting structure disposed between the container 2 and the moving module 4.

2.1 Moving Module 4

Referring to FIGS. 1-2, the moving module 4 comprises a second drive unit 41, a drive screw 42, at least one positioning slide bar 43 and two positioning slide plates 44.

1) Second Drive Unit 41

Preferably, the second driving device 41 is a driving motor provided with a Hall sensor; the second driving device 41 is configured to control the rotation of the drive screw 42 and drive the container 2 to carry the ingredient box 1 to move along the drive screw 42.

2) Drive Screw 42

The drive screw 42 is disposed below and parallel to the rotating shaft 32; both the two frame plates 5 comprise a second hole 52; two ends of the drive screw 42 is inserted into the two second holes 52, respectively, and is carried by the two frame plates 5; the second drive unit 41 comprises an output end; one end of the drive screw 42 passes through one of the two second holes and is then connected to an output end of the second drive unit 41; the drive screw 42 is driven by the second drive unit and rotates forward or backward.

3) Positioning Slide Bar 43

The at least one positioning slide bar 43 is parallel to the drive screw 42 and the rotating shaft 32; both the two frame plates 5 comprise a third hole 53; two ends of the at least one positioning slide bar 43 is inserted into the two third holes 53, respectively, and is carried by the two frame plates 5.

4) Positioning Slide Plate 44

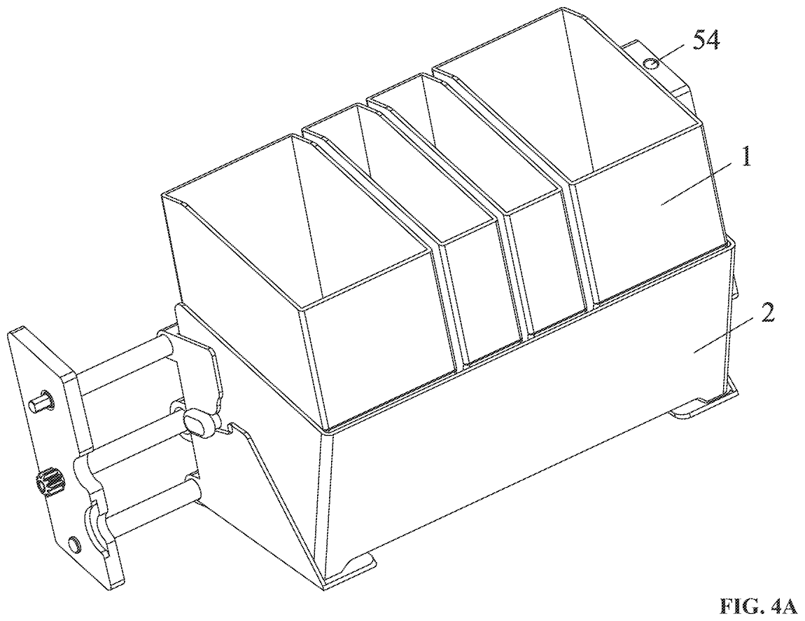

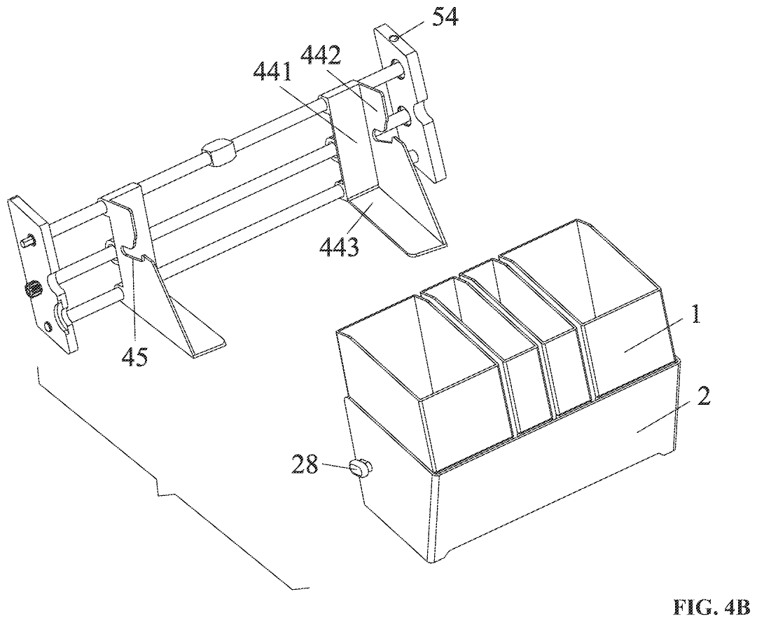

As shown in FIGS. 4A-4B, the two positioning slide plates 44 have the same structure; the container 2 is fixed on the at least one positioning slide bar 43 via the two positioning slide plates 44; and thus the container directionally moves along the drive screw 42.

The container 2 comprises a back plate 24, two side plates 22, and a bottom plate; the two side plates 22 are disposed on the two positioning slide plates 44, respectively; each of the two positioning slide plates 44 comprises a backboard 441, a lateral plate 442 and a lower base plate 443; the backboard 441 is connected to the back plate; the lateral plate 442 is connected to the two side plates as so to prevent potential changes in the position of the container 2; the lower base plate 443 is connected to the bottom plate to support the container 2.

A middle edge of the lateral plate 442 is provided with a gap 45; the container 2 comprises an outer side and a button pin 28 is disposed on the outer side; the button pin 28 is clamped in the gap 45 so that the two positioning slide plates 44 are connected to the container 2.

The button pin 28 is disengaged with the gap 45 and the container 2 is separated from the flipping structure; so that the ingredient box and the container are easy to clean, and new solid or liquid ingredients are added to the ingredient box.

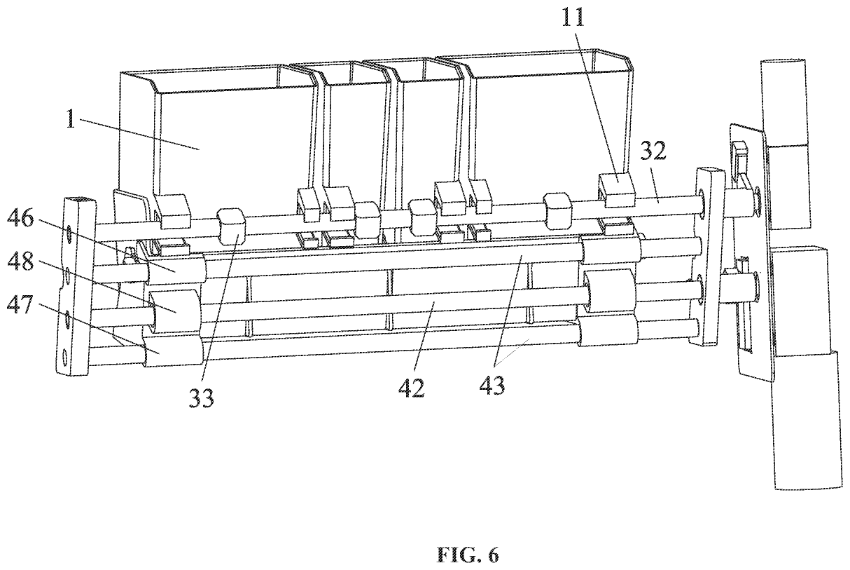

As shown in FIGS. 2 and 6, an upper part and a lower part of a back surface of each of the two positioning slide plates are provided with two sliding sleeves and a threaded sleeve 48; the two sliding sleeves comprises a first sliding sleeve 46 and a second sliding sleeve 47 respectively disposed on the upper part and the lower part of the back surface of each positioning slide plate; the first sliding sleeve 46 in a sliding connection to the rotating shaft 32, and the second sliding sleeve 47 is in a sliding connection to the at least one positioning slide bar 43. The threaded sleeve 48 is disposed between the first sliding sleeve 46 and the second sliding sleeve 47; the threaded sleeve 48 comprises a threaded through hole through which the threaded sleeve is disposed on the drive screw 42; one end of the drive screw 42 is connected to the second drive unit 41; and the container 2 carries the ingredient box and is driven by the second drive unit 41 to move reciprocally along the drive screw 42. In certain examples, the moving module comprises two positioning slide bars respectively in a sliding connection to the two sliding sleeves.; one of the two positioning slide bars is disposed between the rotating shaft and the drive screw, and the other positioning slide bars is disposed below the drive screw.

The first sliding sleeve 46 and the second sliding sleeve 47 are connected to the two positioning slide bar 43 as follows:

1) as shown in FIG. 2, in certain examples, only one positioning slide bar 43 is carried by the two frame plates 5; the first sliding sleeve 46 is disposed on the rotating shaft 32 and the second sliding sleeve 47 is disposed on the only one positioning slide bar 43;

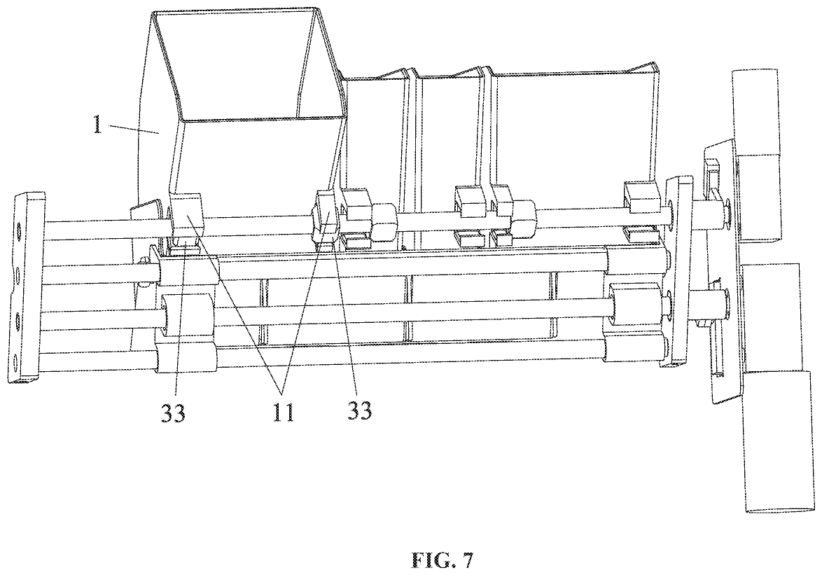

2) as shown in FIGS. 6 and 7, in certain examples, two positioning slide bars 43 are carried by the two frame plates 5; one of the two positioning slide bars is disposed between the rotating shaft 32 and the drive screw 42; the other positioning slide bar is disposed below the drive screw 42; the first sliding sleeve 46 is disposed on the one of the two positioning slide bars 43; the second sliding sleeve 47 is disposed on the other positioning slide bar 43.

As shown in FIGS. 6-10, in certain examples, the two positioning slide bars 43 are carried by the two frame plates 5; a plurality of clamp blocks are spaced apart on the rotating shaft 32 and above the frying pan 210; the container 2 carries the ingredient box and is driven by the second drive unit 41 to move reciprocally in a short distance along the drive screw 42. The space utilization between the two frame plates 5 is improved, increasing the total capacity of the ingredient box 1.

The plurality of clamp blocks 33 are arranged as follows:

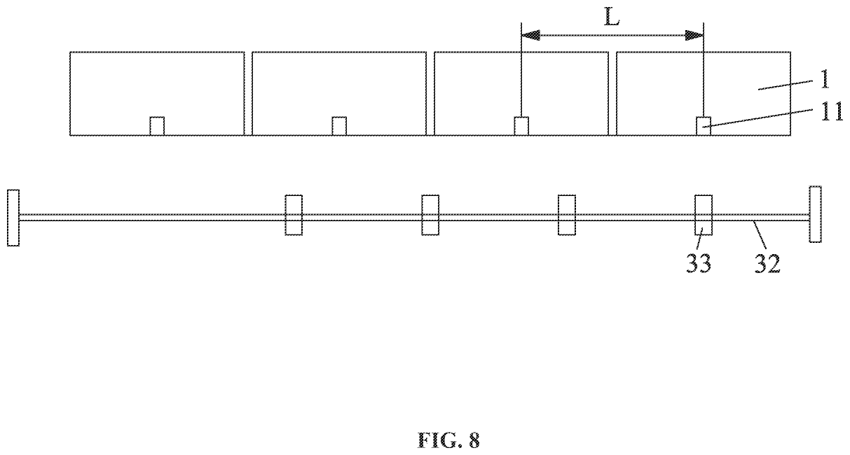

1) As shown in FIG. 8, the plurality of ingredient boxes 1 has the same narrow width; one connecting piece 11 is disposed on the back face of each of the plurality of ingredient boxes 1; each of the plurality of clamp blocks 33 faces a corresponding connecting piece 11; when one of the plurality of ingredient boxes 1 needs to be flipped, one of the plurality of clamp blocks 33 is clamped in the slot 12 of the corresponding connecting piece 11; so that the container carries the corresponding ingredient box to turn over around the rotating shaft; and the other clamp blocks are respectively disengaged with the corresponding slots 12.

For example, the ingredient loading device comprises n ingredient boxes and n clamp blocks; the distance between every two adjacent slots is L, and a moving unit Q=L/n [or L/(n+1)], then the distance between every two adjacent clamp blocks is (L−Q).

As a result, the container 2 moves only within the width of one ingredient box, and the ingredient boxes are turned over around the drive screw in sequence.

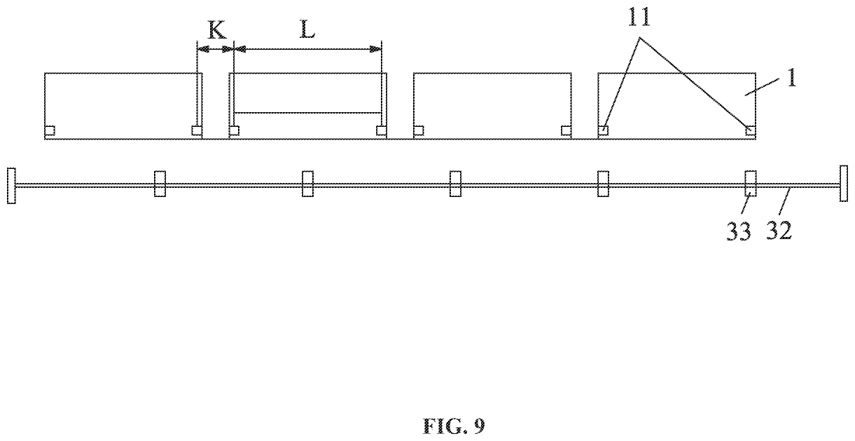

2) As shown in FIG. 9, the plurality of ingredient boxes 1 has the same narrow width; two connecting pieces 11 are disposed on the back face of each of the plurality of ingredient boxes 1; two of the plurality of clamp blocks 33 are respectively connected to the two corresponding connecting piece 11 and respectively clamped in the corresponding slots 12 of the two connecting pieces 11, so that the container carries the corresponding ingredient box to turn over around the rotating shaft; and the other clamp blocks are disengaged with the corresponding slots 12. The two connecting pieces 11 are configured to support the whole weight of the ingredients and the ingredient boxes 1.

For example, the ingredient loading device comprises n ingredient boxes and m clamp blocks; the distance between every two adjacent slots or every two ingredient boxes is L; the distance between every two adjacent clamp blocks on two adjacent ingredient boxes is k; a moving unit Q=L/n[or L/(n+1)], k=AL/n (A is an integer); when A=1, different ingredient boxes 1 can be turned over by only moving one moving unit Q one by one.

As a result, the container 2 moves only within the width of one ingredient box, and the ingredient boxes are turned over around the drive screw in sequence.

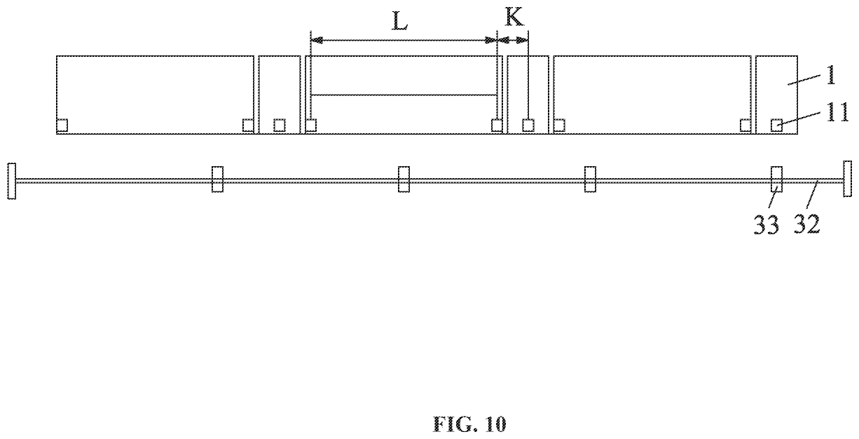

3) As shown in FIG. 10, the ingredient loading device comprises a plurality of wide ingredient boxes and narrow ingredient boxes used in conjunction to meet the requirements of a ratio of the amount of a variety of ingredient items. Each ingredient boxes 1 comprises at least one connecting piece 11; when one of the plurality of ingredient boxes 1 needs to be flipped, at least one clamp block is correspondingly clamped in the slot 12 of the at least one connecting piece 11 of the one ingredient box, and other clamp blocks are disengaged with slots of connecting pieces of the ingredient boxes 1 not to be flipped.

For example, the wide ingredient boxes and the narrow ingredient boxes are arranged in pairs, the ingredient loading device comprises n ingredient boxes, including i wide ingredient boxes, j narrow ingredient boxes, and m clamp blocks; the distance between every two adjacent slots of one wide ingredient box is L; the distance between every two adjacent slots on two adjacent ingredient boxes is k; a mobile unit Q=L/n, k=AL/n (A is an integer); as a result, the container 2 moves only within the width of one ingredient box, and the ingredient boxes are turned over around the drive screw in sequence.

2.2 A Method for Operating the Ingredient Loading Device 10

1) The two positioning slide plates 44 are disposed on the positioning slide bars 43, the rotating shaft 32 and the drive screw 42; and the positioning slide bars 43, the rotating shaft 32 and the drive screw 42 are carried by the two frame plates.

2) The plurality of ingredient boxes is disposed in the container 2; the container 2 is connected to the two positioning slide plates 44.

3) The drive screw 42 is driven by second drive unit 42 and carries the threaded sleeve 48 to rotate, so that the two positioning slide plates 44 carries the container 2 to move along the rotating shaft.

4) The container 2 carries the ingredient boxes to stay above the opening of the frying pan 210; the clamp blocks are clamped in the slots of the connecting pieces of the ingredient boxes.

5) The rotating shaft 32 is driven by the first drive unit 31 and rotate, causing the ingredient boxes to turn over above the opening of the frying pan 210; and the ingredients in the ingredient boxes are poured into the frying pan 210.

6) The first driving unit is driven in reverse direction; as the rotating shaft 32 rotates, the ingredient boxes move back into the container 2; the container is driven by the second drive unit 41 and carries the ingredient boxes to stay above the opening pf the frying pan 210.

7) The next ingredient box stays above or move away from the opening of the frying pan 210 according to the above method.

3. Automatic Stir-Fryer 200

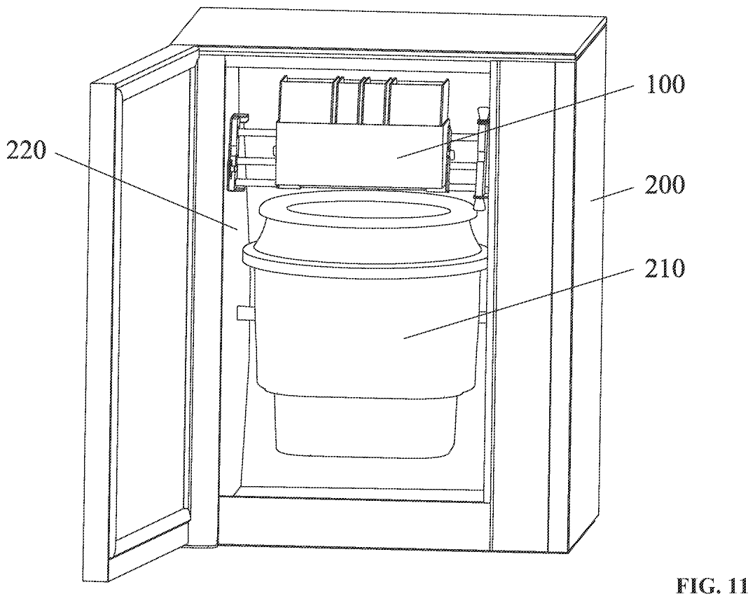

As shown in FIGS. 11-13B, the automatic stir-fryer 200 comprises a chamber 220, a frying pan 210 and the ingredient loading device 100; the ingredient loading device is disposed above the opening of the frying pan 210 to add the ingredients to the frying pan 210.

The chamber 220 comprises a first inner wall provided with a first supporting plate 221 and a second inner wall provided with a second supporting plate 222.

The first supporting plate 221 and the second supporting plate 222 are integrated plates each comprising an upper plate 223, a lower plate 224, a base plate 225 and a baffle plate 226; the two base plates 225 are fixedly connected to the first supporting plate 221 and the second supporting plate 222, respectively; the upper plate 223 and the lower plate 224 are connected to both ends of the base plate 225, respectively, and disposed parallel to each other; the baffle plate 226 is disposed on one end of the upper plate 223; and the other baffle is disposed on one end of the lower plate 224.

The lower plate 224 is configured to support the two frame plates 5 and prevent the two frame plates from sliding backward; the upper plate 223 is configured to prevent the potential changes in the position of the two frame plates 5, thus increasing the stability of the flipping structure.

3.1 First Supporting Plate 221

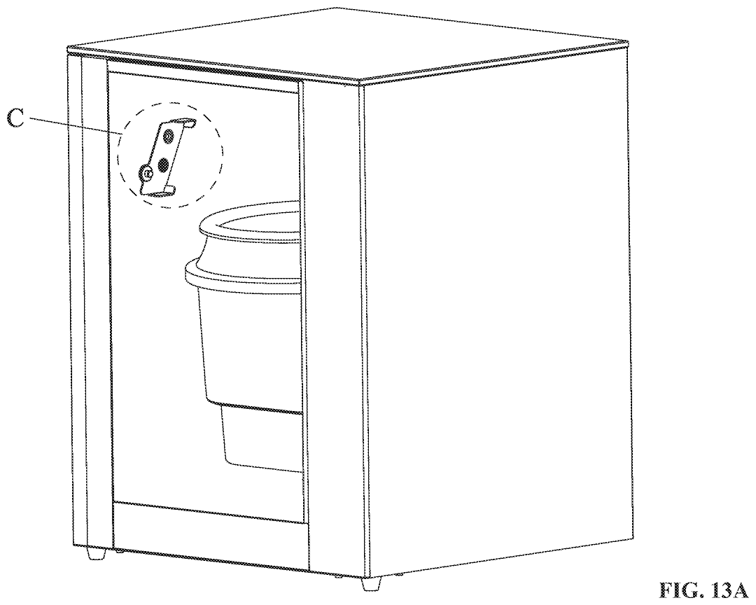

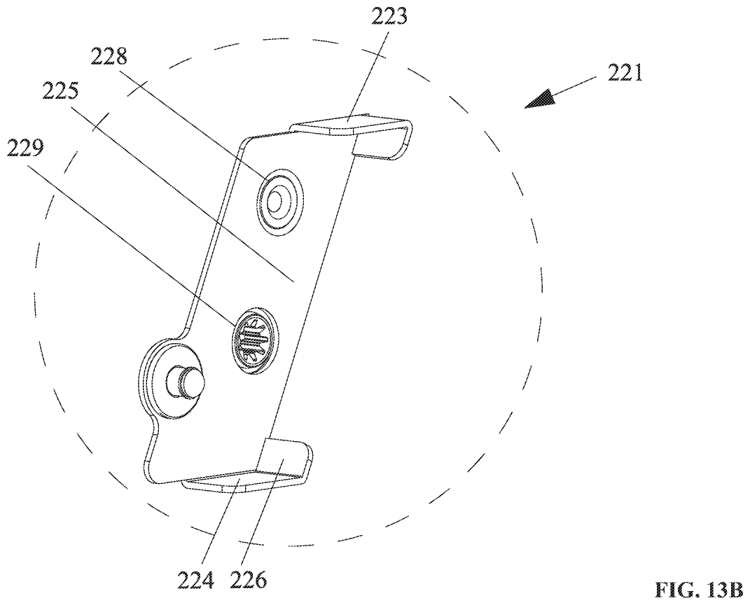

As shown in FIGS. 13A-13B, the first supporting plate 221 is provided with a first through hole 228 for receiving the rotating shaft and a second through hole 229 for receiving the drive screw;

3.2 Second Supporting Plate 222

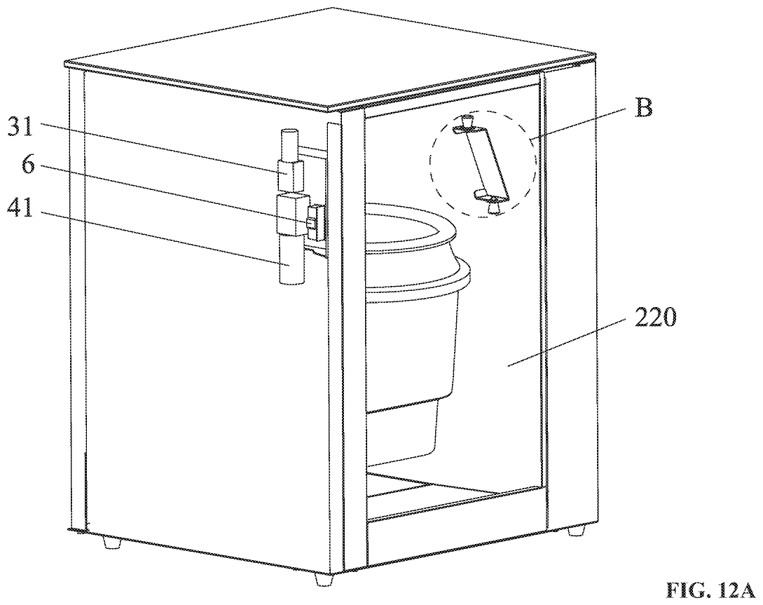

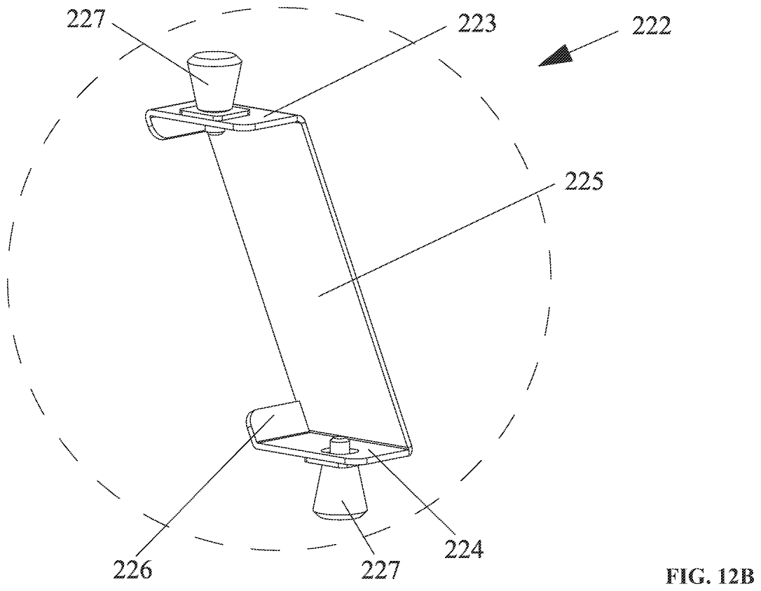

As shown in FIGS. 12A-12B, both the upper plate 223 and the lower plate 224 are provided with a locking piece 227; preferably, the locking piece 227 is a spring plunger detachably disposed between the upper plate 223 and the lower plate 224; one of the two frame plates 5 comprises a fourth hole 54; the locking piece 227 is fixed in or dislodged from the fourth hole 54 so that the second supporting plate 222 is connected to or separated from the one of the two frame plates 5.

In certain examples, two locking piece 227 are disposed on the first supporting plate 221 and the second supporting plate 222, respectively. In the example, only one locking piece 227 is fixed on the second supporting plate 222 so that the second supporting plate 222 is connected to the one of the two frame plates 5.

3.3 Assembly and Disassembly of Ingredient Loading Device 100

As shown in FIGS. 12A-13B, the first drive unit 31, the second drive unit 41 and the limit switch 6 are disposed on an outer wall of the first inner wall of the chamber 220; the other parts of the ingredient loading device 100 constitute an integrated structure carried by the two frame plates; specifically, the ingredient loading device 5 is fixedly or detachably disposed in the automatic stir-fryer through the two frame plates 5. A method for assembling the automatic stir-fryer is described as follows:

1) the first supporting plate 221 and the second supporting plate 222 are carried by the two frame plates 5; the baffle plate 226 is configured to prevent potential changes in the position of the two frame plates, so that the rotating shaft 32 and the drive screw 42 are inserted into the first through hole 228 and the second through hole 229, respectively;

2) the rotating shaft 32 comprises a type-D shaft; the first drive unit 31 comprises a first output end provided with a first coupling; the first coupling comprises a type-D groove; the second drive unit 41 comprises a second output end provided with a second coupling; the second coupling comprises a splined groove; one end of the type-D shaft passes through the first through hole 228 and is fitted into the type-D groove; one end of the drive screw 42 is fixedly connected to a splined shaft; the splined shaft passes through the second through hole 229 and is fitted to the splined groove; therefore, the rotating shaft 32 and the drive screw 42 are respectively in a stable connection to the first drive unit 31 and the second drive unit 41; and

3) the spring plunger is fixed in the fourth hole 54.

A method for disassembling the automatic stir-fryer is described as follows:

1) the spring plunger is dislodged from the fourth hole 54;

2) the rotating shaft 32 and the drive screw 42 are respectively separated from the first drive unit 31 and the second drive unit 41 and are then respectively dislodged from the first through hole 228 and the second through hole 229; and

3) each of the two frame plates 5 are separated from the upper plate 223 and the lower plate 224.

The locking piece 227 is fixed in or dislodged from the fourth hole so that the two frame plates 5 are connected to or separated from the second supporting plate 222, making the ingredient loading device 100 and the chamber 220 easy to maintain and clean.

It will be obvious to those skilled in the art that changes and modifications may be made, and therefore, the aim in the appended claims is to cover all such changes and modifications.

What is claimed is:

1. A flipping structure for an automatic stir-fryer, the flipping structure comprising:
an ingredient box;
a container for carrying the ingredient box;
a moving module configured to directionally move the container; and
a driving mechanism for flipping the ingredient box;
wherein:
the driving mechanism comprises a rotating shaft and at least one clamp block fixedly disposed on the rotating shaft;
the ingredient box comprises a front face, a back face, and a connecting piece, and the connecting piece is fixed on the front face or the back face; the connecting piece comprises a slot;
when in use, the ingredient box moves with the container to face the at least one clamp block, and the at least one clamp block is nested in the slot; the clamp block is clamped in the slot through a clearance fit; as the rotating shaft rotates, the clamp block carries the ingredient box to turn over around the rotating shaft.

2. The flipping structure of claim 1, wherein the clamp block is a member sleeved or welded to the rotating shaft, and has a triangular, quadrilateral, pentagonal or oval cross section perpendicular to the rotating shaft.

3. The flipping structure of claim 2, wherein the connecting piece is an integrated structure comprising a base board, an upper board, and a lower board; the base board is fixed on the ingredient box; the upper board and the lower board are connected to an upper end and a lower end of the base board, respectively; and the slot is formed by space between the upper board and the lower board.

4. The flipping structure of claim 3, wherein a fixing unit is disposed between an inner surface of the container and an outer surface of the ingredient box to prevent the ingredient box from wobbling in the container.

5. An ingredient loading device for an automatic stir-fryer, comprising a flipping structure of claim 1 and two frame plates; wherein
the driving mechanism of the flipping structure further comprises a first drive unit; two ends of the rotating shaft are respectively carried by the two frame plates; the first drive unit comprises an output end fixedly connected to one end of the rotating shaft;
the moving module of the flipping structure comprises a second drive unit, a drive screw, two positioning slide plates and at least one positioning slide bar; two ends of both the drive screw and the at least one positioning slide bar are carried by the two frame plates, respectively; the rotating shaft, the at least one positioning slide bar and the drive screw are parallel to each other; the two positioning slide plates are respectively connected to two sides of a front face or a back face of the container; an upper part and a lower part of a back surface of each of the two positioning slide plates are provided with two sliding sleeves, respectively; one of the two sliding sleeves is in a sliding connection to the rotating shaft and the other sliding sleeve is in a sliding connection to the at least one positioning slide bar; each of the two positioning slide plates further comprises a threaded sleeve disposed between the two sliding sleeves; the threaded sleeve is disposed on the drive screw; one end of the drive screw is connected to an output end of the second drive unit; and the container carries the ingredient box and is driven by the second drive unit to move reciprocally along the drive screw.

6. An ingredient loading device for an automatic stir-fryer, comprising a flipping structure of claim 1 and two frame plates; wherein
the driving mechanism of the flipping structure further comprises a first drive unit; two ends of the rotating shaft are respectively carried by the two frame plates; the first drive unit comprises an output end fixedly connected to one end of the rotating shaft;
the moving module of the flipping structure comprises a second drive unit, a drive screw, two positioning slide plates and two positioning slide bars; two ends of both the drive screw and the two positioning slide bars are carried by the two frame plates, respectively; the rotating shaft, the two positioning slide bars and the drive screw are parallel to each other; the two positioning slide plates are respectively connected to two sides of a front face or a back face of the container; an upper part and a lower part of a back surface of each of the two positioning slide plates are provided with two sliding sleeves, respectively; the two positioning slide bars are respectively in a sliding connection to the two sliding sleeves; one of the two positioning slide bars is disposed between the rotating shaft and the drive screw, and the other positioning slide bar is disposed below the drive screw; each of the two positioning slide plates further comprises a threaded sleeve disposed between the two sliding sleeves; the threaded sleeve is disposed on the drive screw; one end of the drive screw is connected to an output end of the second drive unit; and the container carries the ingredient box and is driven by the second drive unit to move reciprocally along the drive screw.

7. The ingredient loading device of claim 5, wherein the clamp block is a member sleeved or welded to the rotating shaft, and has a triangular, quadrilateral, pentagonal or oval cross section perpendicular to the rotating shaft.

8. The ingredient loading device of claim 7, wherein the connecting piece is an integrated structure comprising a base board, an upper board, and a lower board; the base board is fixed on the ingredient box; the upper board and the lower board are connected to an upper end and a lower end of the base board, respectively; and the slot is formed by space between the upper board and the lower board.

9. The ingredient loading device of claim 8, wherein a fixing unit is disposed between an inner surface of the container and an outer surface of the ingredient box to prevent the ingredient box from wobbling in the container.

10. The ingredient loading device of claim 6, wherein the clamp block is a member sleeved or welded to the rotating shaft, and has a triangular, quadrilateral, pentagonal or oval cross section perpendicular to the rotating shaft.

11. The ingredient loading device of claim 10, wherein the connecting piece is an integrated structure comprising a base board, an upper board, and a lower board; the base board is fixed on the ingredient box; the upper board and the lower board are connected to an upper end and a lower end of the base board, respectively; and the slot is formed by space between the upper board and the lower board.

12. The ingredient loading device of claim 11, wherein a fixing unit is disposed between an inner surface of the container and an outer surface of the ingredient box to prevent the ingredient box from wobbling in the container.

13. The ingredient loading device of claim 5, wherein each of the two positioning slide plates comprises a backboard, a lateral plate and a lower base plate; the two sliding sleeves and the threaded sleeve are disposed on an outer surface of the backboard; a middle edge of the lateral plate is provided with a gap; the container is supported by the lower base plate; the container comprises an outer side and a button pin is disposed on the outer side; and the button pin is clamped in the gap so that the two positioning slide plates are connected to the container.

14. The ingredient loading device of claim 13, comprising a plurality of ingredient boxes each with at least one connecting piece, wherein when one of the plurality of ingredient boxes needs to be flipped, at least one clamp block is correspondingly clamped in the slot of the at least one connecting piece of the one ingredient box, and other clamp blocks are disengaged with slots of connecting pieces of the ingredient boxes not to be flipped.

15. The ingredient loading device of claim 14, wherein for a wide ingredient box, the wide ingredient box comprises two connecting pieces disposed on two sides of the wide ingredient box, respectively.

16. The ingredient loading device of claim 6, wherein each of the two positioning slide plates comprises a backboard, a lateral plate and a lower base plate; the two sliding sleeves and the threaded sleeve are disposed on an outer surface of the backboard; a middle edge of the lateral plate is provided with a gap; the container is supported by the lower base plate; the container comprises an outer side and a button pin is disposed on the outer side; and the button pin is clamped in the gap so that the two positioning slide plates are connected to the container.

17. The ingredient loading device of claim 16, comprising a plurality of ingredient boxes each with at least one connecting piece, wherein when one of the plurality of ingredient boxes needs to be flipped, at least one clamp block is correspondingly clamped in the slot of the at least one connecting piece of the one ingredient box, and other clamp blocks are disengaged with slots of connecting pieces of the ingredient boxes not to be flipped.

18. The ingredient loading device of claim 17, wherein for a wide ingredient box, the wide ingredient box comprises two connecting pieces disposed on two sides of the wide ingredient box, respectively.

19. An automatic stir-fryer, comprising a chamber, a frying pan, and the ingredient loading device of claim 6; wherein the ingredient loading device is disposed above an opening of the frying pan; the chamber comprises a first inner wall provided with a first supporting plate and a second inner wall provided with a second supporting plate; both the first supporting plate and the first inner wall are provided with a first through hole for receiving the rotating shaft and a second through hole for receiving the drive screw; the second supporting plate is provided with a locking piece; each of the two frame plates comprises a hole; the locking piece is fixed in the hole, and the two frame plates are disposed between the first supporting plate and the second supporting plate; and one end of the rotating shaft and one end of the drive screw respectively pass through the first through hole and the second through hole and are connected to output ends of the first drive unit and the second drive unit disposed on an outer wall of the chamber.

20. The automatic stir-fryer of claim 19, comprising a plurality of ingredient boxes each with at least one connecting piece, wherein when one of the plurality of ingredient boxes needs to be flipped, at least one clamp block is correspondingly clamped in the slot of the at least one connecting piece of the one ingredient box, and other clamp blocks are disengaged with slots of connecting pieces of the ingredient boxes not to be flipped.
